(19) United States
(12) Patent Application Publication
(10) Pub. No.: US 2009/0199867 A1
(43) Pub. Date: Aug. 13, 2009

(54) Sole cleaning device

(76) Inventor: Bruce Ernest Woods, Swainsboro, GA (US)

Correspondence Address: MICHAEL J. BOOTCHECK, LLC, P.O. BOX 3505, MCDONOUGH, GA, 30253, US

(21) Appl. No.: 12/069,471

(22) Filed: Feb. 11, 2008

(51) Int. Cl. A47L 23/02; A47L 23/26; B08B 7/00

(52) U.S. Cl. 134/6; 15/21.1; 15/257.1

(57) ABSTRACT

A device for cleaning soles of footwear with a plurality of rotatable horizontal brushes. A motor may be used to drive each of the brushes. A tray for collecting dirt and other debris may be located under the brushes in order to provide a convenient method to remove dirt and other debris from the device after use. Such devices may permit a person or persons to clean mud, snow, sand, dirt and the like from the soles of their footwear without need of removing the footwear from their feet.

### FIELD OF THE INVENTION

The present invention relates to devices which can be used by an individual to clean the soles of shoes and other footwear. The device relates more specifically to a powered sole cleaning device which can be placed onto the floor or other surface such that a person wearing shoes may step onto the device and a plurality of brushes will clean the soles of the footwear.

### BACKGROUND OF THE INVENTION

Prior art machines for cleaning the soles of shoes are generally either stationary as in mats, rugs, and bristled brushes. Other devices are available for mechanically cleaning upper portions of shoes, such as buffing machines, but they do not offer the ability for a person to have the machine clean the sole of the shoe, particularly when the person is still wearing the shoe.

### SUMMARY OF THE INVENTION

The present invention is directed to a novel sole cleaning device which allows an individual to utilize the device to clean the soles of their footwear without the need to remove their footwear in some embodiments. The devices may be constructed to various dimensions and configurations to fit into a multitude of locations. The present invention provides a sole cleaning device which is particularly suitable for households, commercial locations, and even construction sites as it can provide a convenient hands free mechanism for cleaning dirt and other debris from shoes quickly and efficiently. Other possible locations where the present invention may be used include hospitals and other areas where dirt and other contaminants can pose a health or other risk. Such devices may be used indoors or outdoors and may be either manually or automatically operated.

According to one exemplary embodiment of the present invention, the device comprises a housing having a plurality of horizontally mounted rotatable brushes each having a plurality of bristles thereon, at least one support grid having a plurality of slats, a motor for driving the plurality of brushes, a power source for powering the motor wherein the motor causes the plurality of brushes to rotate and a person may stand on the device and wherein the soles are cleaned by relative motion of the brushes and wherein an upper portion of each of the plurality of brushes is at least temporarily positioned above the grid and a lower portion of each of the plurality of brushes is positioned below the grid.

In another exemplary embodiment, the device comprises a housing, a first set of horizontal cylindrical brushes with bristles including a first brush and a second brush wherein a longitudinal axis of the first brush and a longitudinal axis of the second brush are parallel to each other, and a second set of horizontal cylindrical brushes with bristles including a plurality of brushes wherein all of the longitudinal axis of each of the second set of horizontal cylindrical brushes is parallel to each other and wherein each of the axis of the first set of horizontal cylindrical brushes is perpendicular to each of the axis of the second set of horizontal cylindrical brushes.

Another embodiment comprises a novel method for cleaning the sole of a shoe comprising a device having a housing having a plurality of horizontally mounted rotatable brushes each having a plurality of bristles thereon, at least one support grid having a plurality of slats, a motor for driving the plurality of brushes, a power source for powering the motor wherein the motor causes the plurality of brushes to rotate and a person may stand on the device and wherein the soles are cleaned by relative motion of the brushes wherein the method includes the steps of placing a sole of footwear downwardly onto the grid, and activating the motor such that the brushes are caused to rotate wherein the brushes clean the soles of the footwear and wherein the soles remain stationary in relation to the grid.

### BRIEF DESCRIPTION OF THE FIGURES

FIG. 1 depicts a perspective view of an exemplary embodiment of the present invention illustrating a person using the device;

FIG. 2 illustrates a perspective view of another exemplary embodiment of the present invention;

FIG. 3 illustrates another perspective view of the exemplary embodiment of FIG. 2;

FIG. 4 illustrates a partial top view of a grid portion of the embodiment of FIG. 1;

FIG. 5 illustrates a partial top view of the exemplary embodiment of FIGS. 1 & 4 when the grid has been removed to show the brushes;

FIG. 6 illustrates another partial top view of the exemplary embodiment of FIGS. 1, 4-5 showing a location of a motor to drive the brushes;

FIG. 7 illustrates a partial cross-sectional view of the exemplary embodiment of FIGS. 1, 4-6 illustrating a gear configuration for driving the brushes;

FIG. 8 illustrates a front view of another embodiment of the present invention;

FIG. 9 illustrates a partial cross-sectional front view of the exemplary embodiment of FIG. 8;

FIG. 10 illustrates a perspective view of an embodiment of the present invention showing various brushes;

FIG. 11 illustrates a perspective view of an embodiment of the present invention showing various rollers;

FIG. 12 illustrates a partial cross-sectional view of an embodiment of the present invention; and

FIG. 13 illustrates a partial side cross-sectional view of an embodiment of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

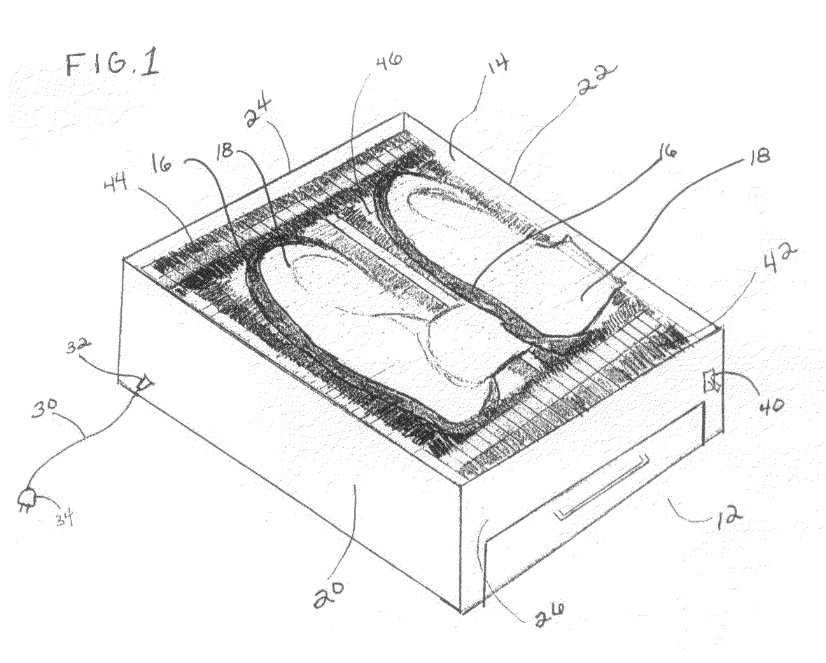

The present invention is directed to devices that may be utilized to mechanically clean the sole of a shoe or other footwear. The devices of the present invention may be utilized in numerous configurations and may be installed in an infinite number of locations due to its variable configuration. Such devices may be installed at an infinite number of residential and commercial locations, such as hospitals and construction sites, wherever a person or business would like to be able to easily, efficiently, and quickly have their soles cleaned in order to remove dirt and other debris from their shoes. One exemplary device of the present invention is shown in FIGS. 1-7.

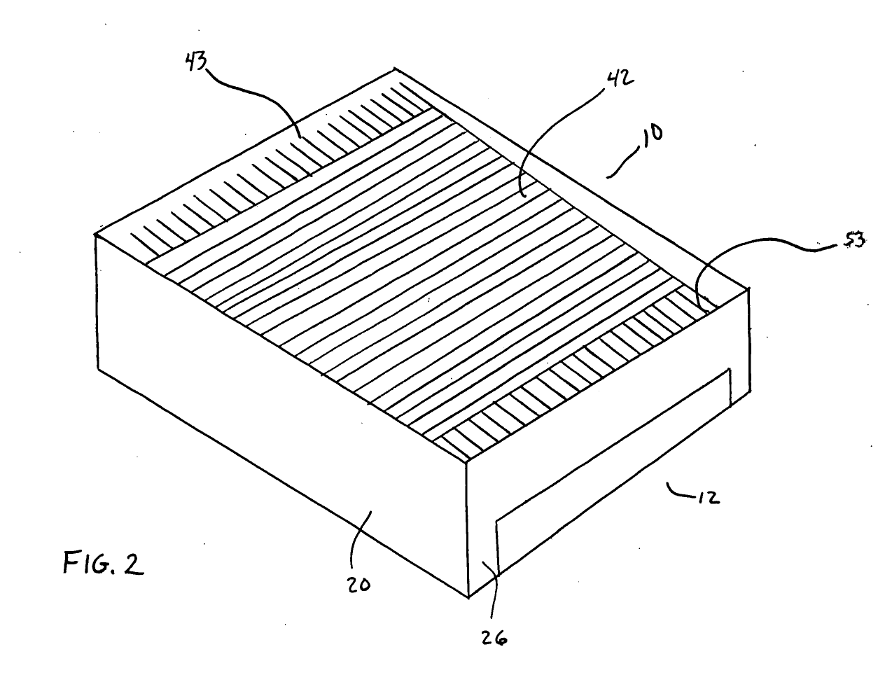

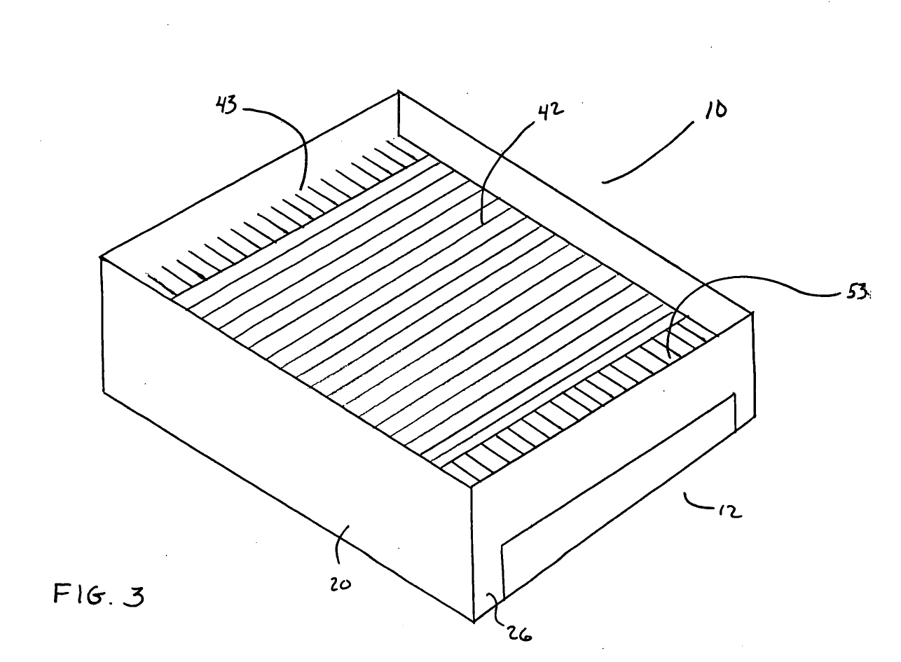

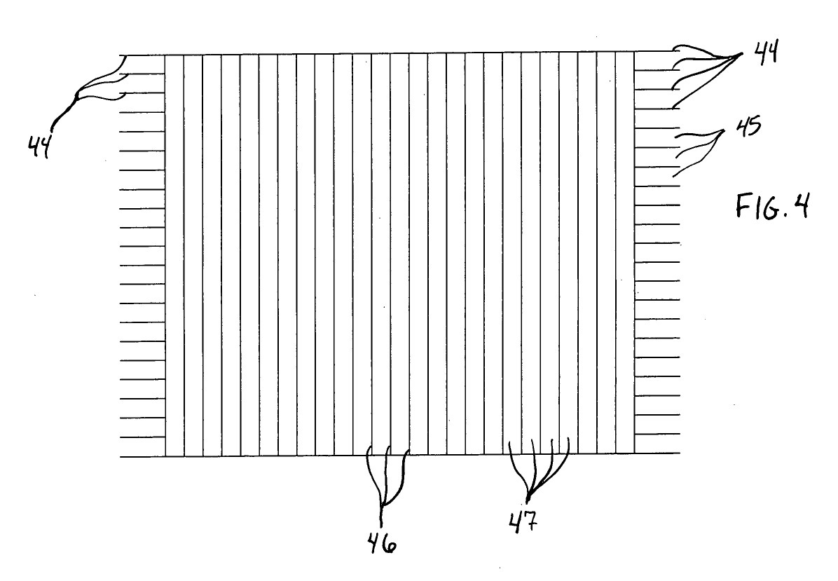

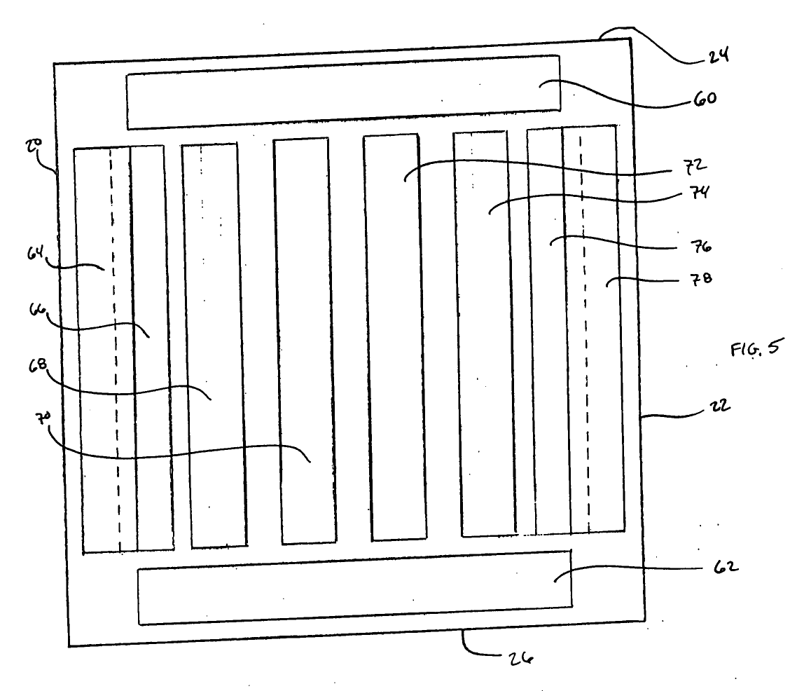

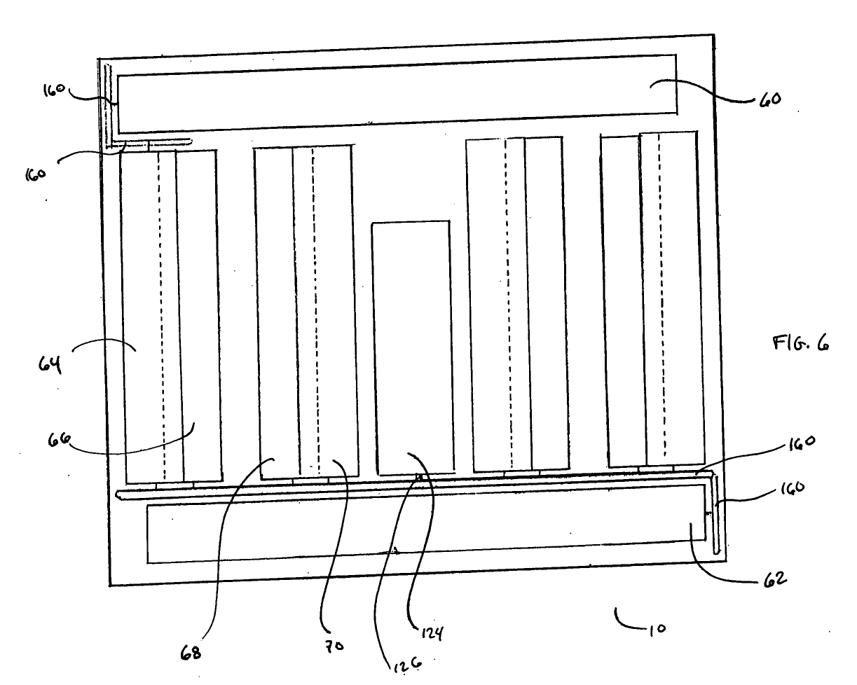

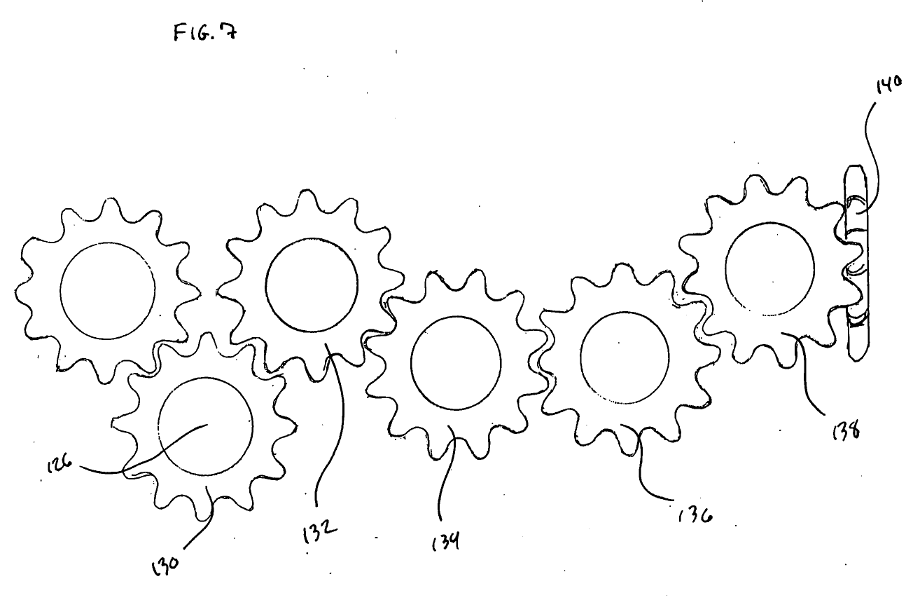

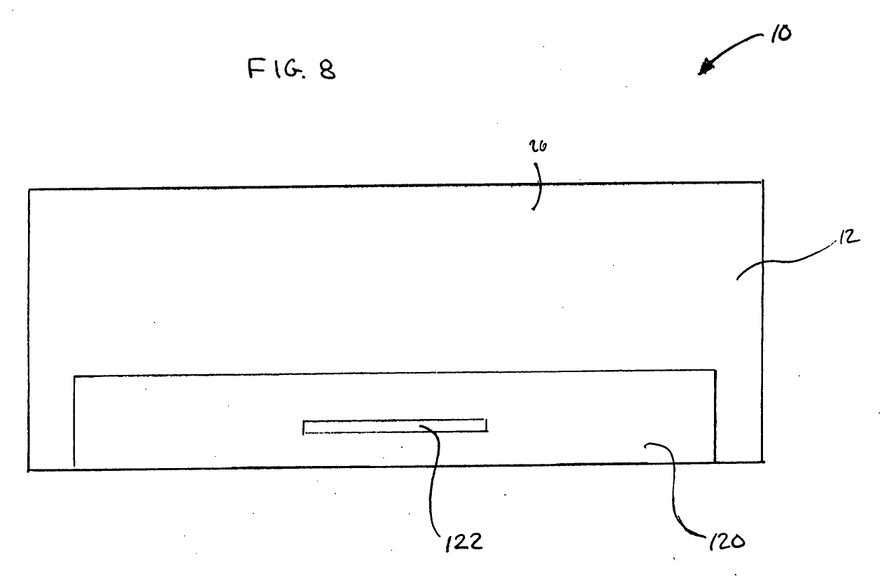

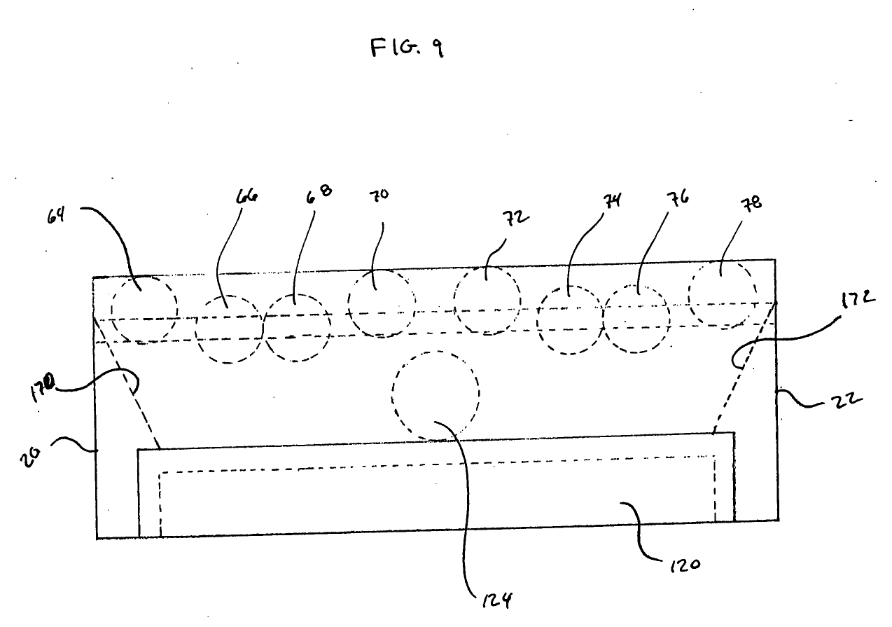

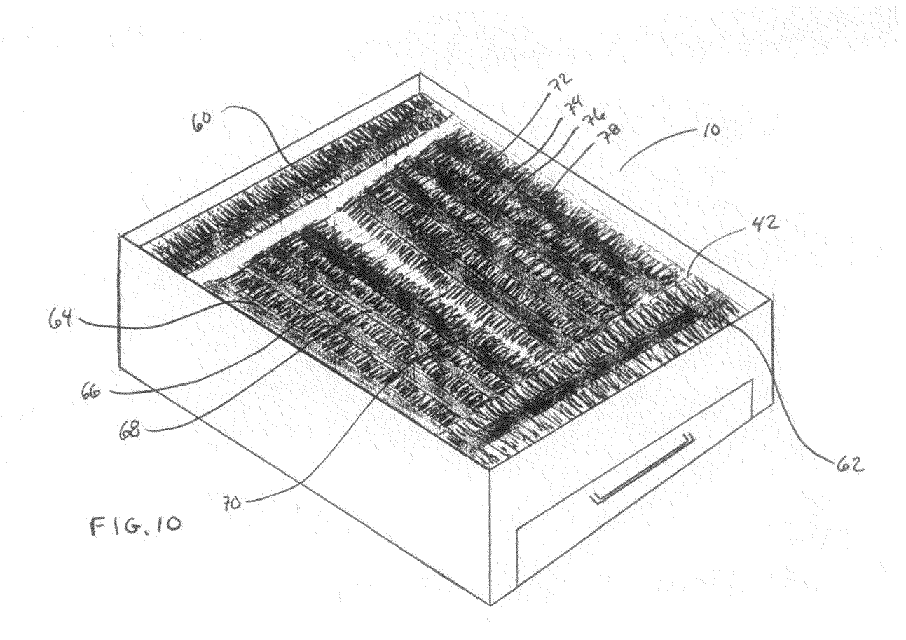

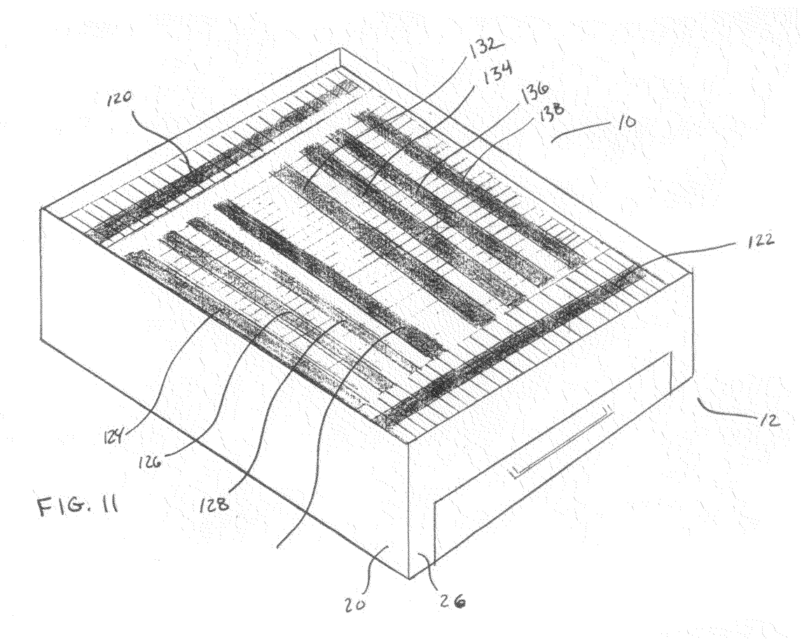

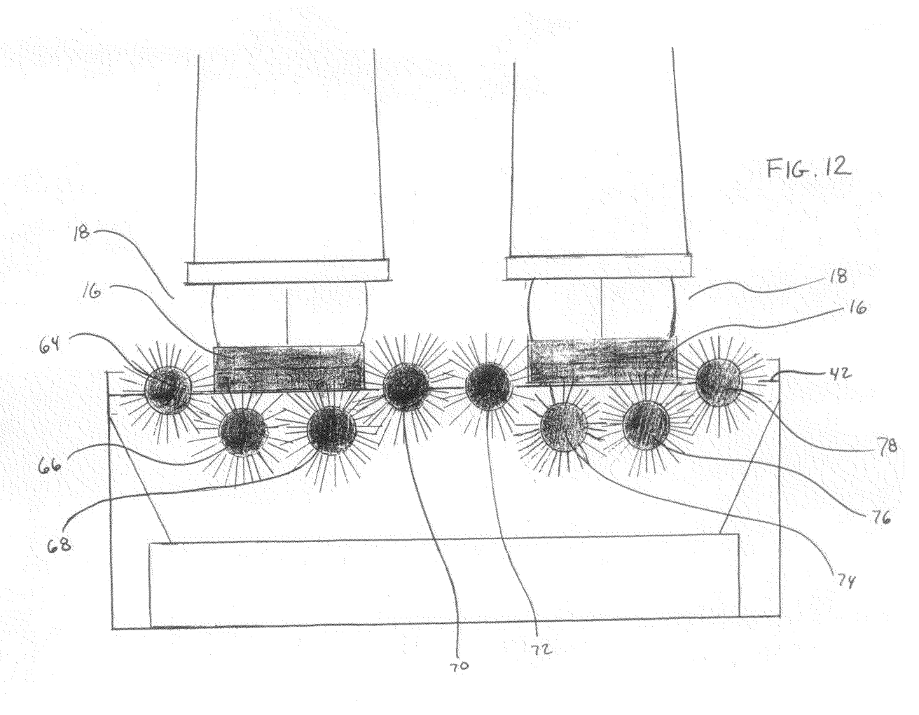

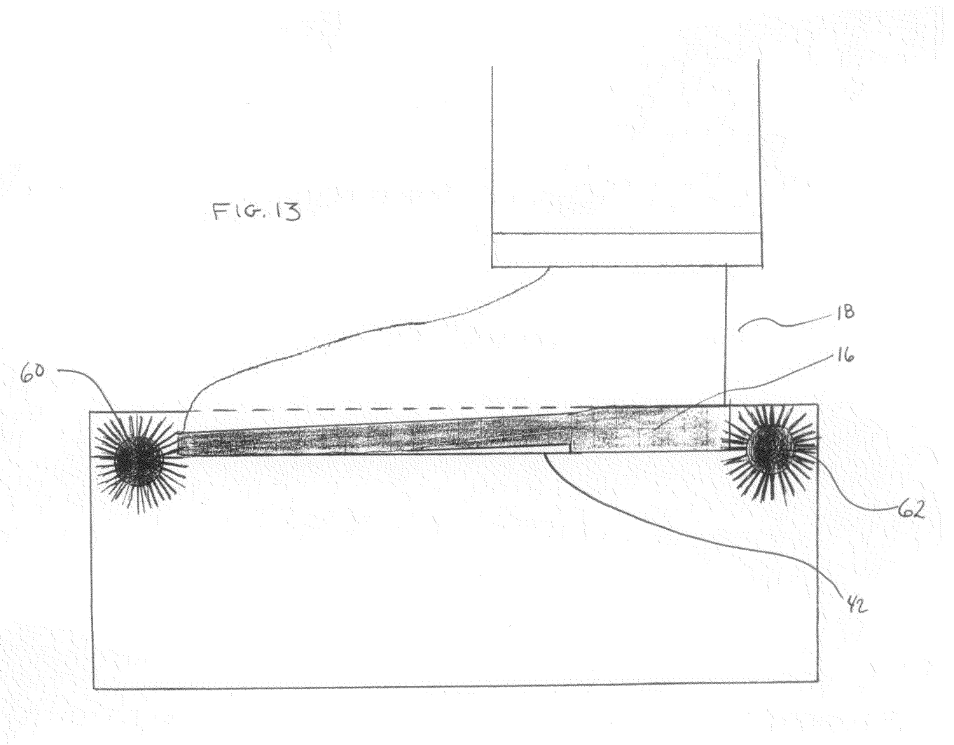

FIG. 1 depicts a perspective view of an exemplary embodiment of the present invention illustrating a person using the device. FIG. 2 illustrates a perspective view of another exemplary embodiment of the present invention. FIG. 3 illustrates another perspective view of the exemplary embodiment of FIG. 2. FIG. 4 illustrates a partial top view of a grid portion of the embodiment of FIG. 1. FIG. 5 illustrates a partial top view of the exemplary embodiment of FIGS. 1 & 4 when the grid has been removed to show the brushes. FIG. 6 illustrates another partial top view of the exemplary embodiment of FIGS. 1, 4-5 showing a location of a motor to drive the brushes. FIG. 7 illustrates a partial cross-sectional view of the exemplary embodiment of FIGS. 1, 4-6 illustrating a gear configuration for driving the brushes. FIG. 8 illustrates a front view of another embodiment of the present invention. FIG. 9 illustrates a partial cross-sectional front view of the exemplary embodiment of FIG. 8. FIG. 10 illustrates a perspective view of an embodiment of the present invention showing various brushes. FIG. 11 illustrates a perspective view of an embodiment of the present invention showing various rollers. FIG. 12 illustrates a partial cross- sectional view of an embodiment of the present invention. FIG. 13 illustrates a partial side cross-sectional view of an embodiment of the present invention.

FIG. 1 illustrates an exemplary embodiment sole cleaning device 10 having a generally parallelepiped shaped frame or housing 12 with a cavity 14 therein (cavity 14 which may extend partly or entirely through housing 12). In this embodiment, frame 12 has a generally rectangular shape bounded by first side 20, second side 22, third side or back 24, and fourth side or front side 26 (floor 28 is not shown). Also shown is power cord 30, which attaches at a first end 32 to housing 12 and has a plug 34 at the other end of power cord 30. Note that although shown with a power cord such that the device may be powered by an alternating source power current, it is also acceptable (and even desirable in some embodiments) for the device to be powered by direct current and/or battery powered.

Switch 40 is also shown in FIG. 1 as a means of turning the device on and off. In other embodiments, such as that shown in FIGS. 2-3, other means may be used to turn the device on and off. In this embodiment, grid 42 may have a first series of slats 44 and a second series of slats 46. Although grid 42 may have any desired configuration, in the illustrated embodiment first series of slats 44 are perpendicular to second series of slats 46.

Internal to housing 12 are a plurality of brushes 60, 62, 64, 66, 68, 70, 72, 74, 76, 78. Each brush has an associated longitudinal shaft (with a shaft axis passing through a centerline of the shaft) 80, 82, 84, 86, 88, 90, 92, 94, 96, 98. Each brush also has an associated cleaning element or bristles 100, 102, 104, 106, 108, 110, 112, 114, 116, 118. In the illustrated embodiment the cleaning elements are a plurality of bristles, each bristle extending from the respective shaft. FIG. 1 shows a portion of the bristles of various brushes extending partially through spaces in the slats of grid 42. Note that although the brushes are cylindrical in shape in this embodiment, various other shapes are also acceptable in accordance with the present invention including, but not limited to, spherical and conical.

In order to utilize the device illustrated, an individual may (1) depress switch 40 (although any suitable type of switch is acceptable) such that the motor is powered on and thus will cause the various brushes (and their associated bristles to rotate), (2) step up onto the device such that the soles of the individuals footwear, such as for example soles 16 of shoes 18, are positioned on grid 42 such that at least a portion of the bristles extend through openings in grid 42 and come into contact with the soles of the footwear such that the soles are cleaned by the action of the bristles, (3) step off of the device after the soles have been cleaned, and then (4) turn off the device by again depressing switch 40.

Frame or housing 12 may be of unitary construction or of multiple components and may be comprised of various materials including, but not limited to, plastic, metal, aluminum, steel, ceramic, and wood. In the embodiment illustrated in FIG. 1, frame 12 is comprised of multiple members or components such that the various components are welded to various other members. Various means may be utilized to secure the various components together such as, but not limited to, screws, gluing, bonding, bolting, welding, and snap fit.

FIG. 2 illustrates a perspective view of another exemplary embodiment of the present invention illustrating device 10 in a de-activated or “off” configuration (note that the views in FIG. 2 and FIG. 3 are simplified to illustrate particularly the arrangement of grid 42 to frame 12). In the illustrated embodiment, grid 42 is pivotable about a pivot axis such that grid 42 can be in at least two configurations, an “off” position in which device 10 is not functioning such that brushes 60, 62, 64, 66, 68, 70, 72, 74, 76, 78 (not shown) are not rotating and a second configuration in which device 10 is in an “on” configuration in which brushes 60, 62, 64, 66, 68, 70, 72, 74, 76, 78 (not shown) are rotating. In this embodiment, grid 42 may be spring biased to the “off” position by use of a spring such that when the spring is relaxed, the device is off. In the illustrated embodiment, a first grid portion 43 may be positioned higher than a second grid portion 53 such as by a spring means which urges grid 42 into such a condition in which grid 42 is in an inclined position relative to a horizontal. By the application of a force to grid 42, grid 42 may be urged to compress the spring or other biasing means to the configuration shown in FIG. 3 such that the device is automatically turned on when in the condition shown in FIG. 3. In some embodiments, a predetermined specific weight may be required before the device can be activated, for example, the device may be set such that a minimum weight of fifty (50) pounds or more must be applied, such as to grid 42, before the device can be activated.

FIG. 3 illustrates another perspective view of the exemplary embodiment of FIG. 2 in which device 10 is in an activated or “on” configuration such that brushes 60, 62, 64, 66, 68, 70, 72, 74, 76, 78 (not shown) are rotating. In this condition, first grid portion 43 and second grid portion 53 of grid 42 may be in a horizontal condition rather than the inclined condition of the embodiment in FIG. 2.

FIG. 4 illustrates a top view of support grid 42 illustrating a first set of struts or slats 44 with spaces 45 therebetween and a second set of slats 46 with spaces 47 therebetween. In the illustrated embodiment the two sets of slats are orthogonal to each other such that when brushes 60, 62, 64, 66, 68, 70, 72, 74, 76, 78 are rotating, their respective bristles can pass through the openings between the slats in order to effectively clean the soles of the footwear.

Note that although illustrated with a plurality of slats and wherein the two sets of slats are orthogonally situated, any suitable number and configuration of slats may be used in accordance with the present invention. In some embodiments, it may be desirable to have more or less slats than illustrated. In yet other embodiments in may be desirable to have a single set of slats.

FIG. 5 illustrates a partial top view of the embodiment of FIGS. 1 & 4 in which grid 42 has been removed to show an arrangement of brushes 64, 66, 68, 70, 72, 74, 76, 78. In this embodiment, two brushes 60, 62 are arranged in a horizontal configuration such that they are parallel to each other whereas a plurality of other brushes 64, 66, 68, 70, 72, 74, 76, 78 are parallel to each other and perpendicular to brushes 60, 62. In this configuration, a person's footwear may be placed such that the long portion of a shoe may be positioned along brushes 64, 66, 68, 70, 72, 74, 76, 78 such that a toe portion of the shoe is positioned proximate either brush 60, 62 and the heel portion of the shoe is proximate the other brush 62, 60. When the device is activated, brushes 60 and 62 may rotate thus cleaning the toe and heel portions of the shoe whereas brushes 64, 66, 68, 70, 72, 74, 76, 78 can clean the other portions of the shoes as illustrated in FIG. 1.

FIG. 6 illustrates an arrangement of sprockets or gearing which may cause the various brushes to rotate. In this embodiment, motor 124 has a shaft extending therefrom which is connected to various gears 160 such that when shaft 126 is rotated, gears 160 are urged to rotate. As shaft 126 rotates, plurality of gears 130, 132, 134, 136, 138, 140, 142, 144, 146, 148 will also rotate which in turn causes brushes 60, 62, 64, 66, 68, 70, 72, 74, 76, and 78 to rotate. Although gears are used to rotate the plurality of brushes in the illustrated embodiment, numerous other methods known in the art may also be used including, but not limited to, belts, magnets, and hydraulics.

FIG. 7 illustrates a partial arrangement of gears which may cause the plurality of brushes to rotate. In the illustrated embodiment, gear 130 is connected to shaft 126. Gear 130 is in contact with gear 132 which is in contact with brush 72 such that when gear 130 is rotated, gear 132 is also caused to rotate which causes brush 72 to rotate. Note that in this embodiment gear 132 is coaxial with the axis of brush 72 (and also may be co-axial with roller 132 as shown in FIG. 11) although this is not required. Similarly, gear 134 (which may be co-axial with brush 74), is then connected to gear 136 (which may be co-axial with brush 76) and so on and so forth.

FIG. 8 illustrates a front view of an alternative embodiment of the present invention. This figure shows a collecting tray 120 in fourth side or front side 26 wherein tray 120 has a handle 122 so that the tray may be accessed or removed so that debris that collects in tray 120 may be emptied after device 10 is used.

FIG. 9 illustrates a partial cross sectional view of the embodiment of FIG. 8 in which tray 120 can be seen in relation to various brushes. In this embodiment, sloping walls 170, 172 extend inwardly in cavity 14 from their respective inner surfaces of first side 20 and second side 22. Such sloping walls 170, 172 can allow for more efficient capture of the dirt and debris which is removed from the soles.

FIG. 10 illustrates a perspective view of an embodiment of the present invention showing various brushes. Note that although a plurality of brushes are illustrated, the number and orientation of brushes can vary depending on the embodiment. In the illustrated embodiment, brushes 60, 62, 64, 66, 68, 70, 72, 74, 76, 78 are shown.

FIG. 11 illustrates a perspective view of an embodiment of the present invention showing various rollers rollers 160, 162, 164, 166, 168, 170, 172, 174, 176, 178

FIG. 12 illustrates a partial cross-sectional view of an embodiment of the present invention. Shown in FIG. 12 are a pair of shoes 18 with respective soles 16 wherein soles 16 are resting on grid 42 and bristles of various brushes 64, 66, 68, 70, 72, 74, 76, 78 are impacting and cleaning soles 16.

FIG. 13 illustrates a partial side cross-sectional view of an embodiment of the present invention. Shown in FIG. 13 is a side view of a shoe 18 with a sole 16 wherein bristles of brushes 60, 62 are impacting and cleaning sole 16. Note that although FIGS. 12 & 13 illustrate a specific number of brushes in a specific orientation more or less brushes may be used in any number of orientations.

The various components and members of the present invention may be comprised wholly or in part of any suitable materials including, but not limited to, steel, aluminum, ceramic, wood, alloys, plastic, rubber, carbon fiber, fiberglass, and stainless steel. The brushes may be comprised of any suitable material including, but not limited to, horsehair, polyester, straw and nylon.

While the specification has been described in detail with respect to specific embodiments thereof, it will be appreciated that those skilled in the art, upon attaining an understanding of the foregoing, may readily conceive of alterations to, variations of, and equivalents to these embodiments. Also note that the housing and other components may be of any suitable shape depending on the desired application for the device. Accordingly, the scope of the present invention should be assessed as that of the appended claims and any equivalents thereto.

What is claimed is:

1. A sole cleaning device for cleaning soles of footwear, said device comprising:
a housing having:
a plurality of horizontally mounted rotatable brushes each having a plurality of bristles thereon,
at least one support grid having a plurality of slats,
a motor for driving said plurality of brushes,
a power source for powering said motor wherein said motor causes said plurality of brushes to rotate and a person may stand on said device and wherein said soles are cleaned by relative motion of said brushes and wherein an upper portion of each of said plurality of brushes is at least temporarily positioned above said grid and a lower portion of each of said plurality of brushes is positioned below said grid.

2. The device of claim 1, wherein said motor is activated by a pressure activated switch such that when the person stands on said device said device is activated and wherein said motor is de-activated when the person steps off of said device.

3. The device of claim 1, wherein said pressure activated switch is switched by an application of force to said grid.

4. The device of claim 1, wherein said power source is by alternating current power.

5. The device of claim 1, wherein said power source is battery powered.

6. The device of claim 1, further comprising a tray which is at least partially contained within said housing and wherein said tray catches dirt and other debris which has been cleaned from the soles of the footwear.

7. The device of claim 6, wherein said tray is removable from said housing.

8. The device of claim 1, wherein said brushes are caused to rotate by a series of gears which connect said motor to said brushes.

9. The device of claim 1, wherein said brushes are caused to rotate by one or more belts which connect said motor to said brushes.

10. The device of claim 1, wherein said plurality of slats comprises a first set of slats and a second set of slats and wherein said first set of slats are in a spaced apart and parallel relation and said second set of slats are in a spaced apart and parallel relation and said first set of slats is perpendicular to said second set of slats.

11. A method of cleaning soles of footwear with the device of claim 1, comprising:
placing a sole of footwear downwardly onto the grid,
activating said motor such that said brushes are caused to rotate wherein said brushes clean the soles of the footwear and wherein said soles remain stationary in relation to said grid.

12. A device for cleaning soles of footwear comprising:
a housing,
a first set of horizontal cylindrical brushes with bristles including a first brush and a second brush wherein a longitudinal axis of said first brush and a longitudinal axis of said second brush are parallel to each other, and
a second set of horizontal cylindrical brushes with bristles including a plurality of brushes wherein all of the longitudinal axis of each of said second set of horizontal cylindrical brushes is parallel to each other
and wherein each of said axis of said first set of horizontal cylindrical brushes is perpendicular to each of said axis of said second set of horizontal cylindrical brushes.

13. The device of claim 12 further comprising a motor for driving said first set of horizontal cylindrical brushes and said second set of horizontal cylindrical brushes.

14. The device of claim 13 wherein said motor is activated by a pressure activated switch when the person stands on said device and wherein said motor is de-activated when the person steps off of said device.

15. The device of claim 12 further comprising a tray which is at least partially contained within said housing and wherein said tray catches dirt and other debris which has been cleaned from the soles of the footwear.

16. The device of claim 12 wherein at least one of said brushes is not co-planar with the other brushes.
